(19) United States
(12) Patent Application Publication
(10) Pub. No.: US 2006/0098904 A1
(43) Pub. Date: May 11, 2006

(54) Bearing element and hydrostatic bearing

(76) Inventor: Christoph Link, Weingarten (DE)

Correspondence Address: VOITH FABRICS, 3040 BLACK CREEK ROAD, P.O. BOX 1411, WILSON, NC, 27893, US

(21) Appl. No.: 11/125,928

(22) Filed: May 10, 2005

(30) Foreign Application Priority Data
Nov. 5, 2004 (DE) 10 2004 023 771.9

(51) Int. Cl. F16C 32/06

(52) U.S. Cl. 384/100

(57) ABSTRACT

The invention relates to a bearing element (1, 1.1, 1.2) having at least one primary sliding surface (4) for supporting at least one secondary sliding surface (5) of an element (2) and having at least one primary bearing surface (6) for its own mounting on a secondary bearing surface (7) of a bearing (8), at least two lubrication pockets (9.1, 9.2) being arranged in the region of the sliding surfaces (4, 5) and at least two bearing pockets (10.1, 10.2) being arranged in the region of the bearing surfaces (6, 7), to which at least one fluid (11) can be applied via channels (K9.1, K9.2, K10.1, K10.2) during operation, in such a way that in each case a hydrostatic gap (12.1, 12.2) can be formed between the sliding surfaces (4, 5) and between the bearing surfaces (6, 7).

The invention is defined in that the respective lubrication pocket (9.1, 9.2) of the preferably primary sliding surface (4) is connected by means of at least one respective fluid connecting line (K10.1, K10.2) to the bearing pocket (10.1, 10.2), arranged in or counter to the direction of action (W4), of the preferably primary bearing surface (6), and in that the bearing pockets (10.1, 10.2) of the preferably primary bearing surface (6) are connected via the preferably secondary bearing surface (7), in each case by means of at least one fluid feed line (K9.1, K9.2), to a fluid pressure source (13, 13.1, 13.2) which can preferably be regulated/controlled.

The invention relates to a bearing element having at least one primary sliding surface for supporting at least one secondary sliding surface of an element and having at least one primary bearing surface for its own mounting on a secondary bearing surface of a bearing, at least two lubrication pockets being arranged in the region of the sliding surfaces and at least two bearing pockets being arranged in the region of the bearing surfaces, to which at least one fluid can be applied via channels during operation, in such a way that in each case a hydrostatic gap can be formed between the sliding surfaces and between the bearing surfaces.

Furthermore, the invention relates to a hydrostatic bearing having at least one bearing element.

Bearings, in particular radial bearings, occur at many points in mechanical engineering, in particular in paper or board machines, in which heavy rolls (shafts) have to be kept exactly in an exactly defined position with respect to their circumferential surface during the rotation of the same. Here, fluctuations in the radial direction of the roll and tilting of the roll with respect to the axis of rotation and therefore with respect to the bearing must be compensated for in order to enjoy precise maintenance of the relative position of the outer circumference of the roll.

Shaken breast rolls, which are equipped with special cylinder roller bearings, are known. The disadvantage with these is that, depending on the loading, specific minimum rotational speeds are necessary before the shake can be activated. Furthermore, it is disadvantageous that these bearings have too short a service life for the respective continuous operation, and are thus costly because of the maintenance which becomes necessary.

Furthermore, bearings in which hydrostatic bearing elements are used are known. A bearing of this type is disclosed, for example, in European patent specification EP 0 535 137 B1. The bearing element has at least one primary sliding surface for supporting at least one secondary sliding surface of a shaft, and at least one primary bearing surface for its own mounting on a secondary bearing surface of a bearing, at least two lubrication pockets being arranged in the region of the primary sliding surface and at least two bearing pockets being arranged in the region of the primary bearing surface, to which at least one fluid can be applied via channels during operation, in such a way that in each case a hydrostatic gap forms between the sliding surfaces and the bearing surfaces.

Depending on the operating pressure of the fluid used therein, this hydrostatic bearing element develops a force which acts against the roll. The disadvantage is that, in the case of this bearing, the gap between the sliding surfaces and the gap between the bearing surfaces is supplied with fluid with equal priority and, in the event of a deficient supply, the gap heights between the sliding surfaces and between the bearing surfaces are reduced. This is relatively harmless for the gap between the bearing surfaces, since here the relative speeds of the parts in relation to each other are low. However, it is critical for the gap between the sliding surfaces, since here high relative speeds of the parts occur. Furthermore, it is a considerable disadvantage that as a result of the manner in which the fluid is supplied, a force acts on the bearing element which attempts to enlarge the gap between the bearing surfaces.

The invention is therefore based on the object of providing both a bearing element that is improved as compared with the prior art and a hydrostatic bearing having at least one bearing element which supports an element in a supportive manner on a sliding surface, the aforementioned disadvantages not occurring and, in particular, the service life being increased as compared with the known bearings.

According to the invention, this object is achieved in a bearing element in that
the respective lubrication pocket of the preferably primary sliding surface is connected by means of at least one respective fluid connecting line to the bearing pocket, arranged in or counter to the direction of action, of the preferably primary bearing surface, and
in that the bearing pockets of the preferably primary bearing surface are connected via the preferably secondary bearing surface, in each case by means of at least one fluid feed line, to a fluid pressure source which can preferably be regulated/controlled.

This produces the advantage that hydrostatic gaps are built up on the sliding surfaces and on the bearing surfaces, and thus any forces for tilting the element which may occur are extremely small, since the bearing surfaces are separated completely from one another by a bearing gap formed between them. Furthermore, both the height of the bearing gap and the height of a sliding gap formed between the sliding surfaces can be defined exactly on account of the feed of a fluid by means of a pressure source that can preferably be regulated/controlled. Furthermore, the sliding gap in which there are high relative speeds, is favored with respect to a volumetric undersupply of the bearing with fluid as compared with the bearing gap with a lower relative speed. In this case, fluid is to be understood to mean any fluid, for example oil or pasty compound, and air, which is suitable to bring about the envisaged volume flow and/or to form the lubricating properties on the element sliding surface.

In a first possible refinement, provision is made for the respective bearing surfaces to have a flat, convex, concave or any desired surface shapes, parallelism or at least approximate parallelism of the surfaces being required. This is advantageous with a view to the use of an element having an unrestricted surface geometry.

With regard to a mounting of the element which is optimized in terms of force, provision is made for the number of lubrication pockets in the region of the preferably primary sliding surface to be equal to the number of bearing pockets in the region of the preferably primary bearing surface. Furthermore, it is advantageous if the respectively interconnected pockets of the preferably primary surfaces have an equal or approximately equal area ratio, the hydrostatically active total area at the bearing gap preferably being smaller than the hydrostatically active total area at the sliding gap. In this case, the pockets of the preferably primary surfaces can have a total area which lies in the range from 10 to 95% of the total active area of the pockets of the preferably primary surfaces.

Furthermore, the respective fluid connecting line and the fluid feed line to each bearing pocket have an element, in particular a restrictor, which produces a pressure drop in the event of through flow. The volume flow resulting from the pressure drop in each case determines the height of the respective gap.

The bearing element is preferably spherical in the region of the primary bearing surface for the purpose of free angular adjustment, being mounted over an area in the secondary bearing surface in a correspondingly oppositely formed sphere of the bearing, the two bearing surfaces being parallel or approximately parallel to each other. In this way, a bearing is likewise made possible in which its sliding surfaces permit an angled setting with respect to the element to be supported, that is to say these can also compensate for tilting of an element, the sliding surfaces in this case being separated from each other by a hydrostatic film.

In a further possible embodiment, the primary sliding surface is concavely shaped and embraces at most a circumferential angle of 180° of the preferably rotating element. In this case, the bearing element preferably assumes the shape of a half-round bearing shell for the preferably rotating element. This permits optimum support of the element.

Furthermore, with regard to the operational reliability of the bearing element, it is advantageous if the fluid feed line has a total quantity of fluid flowing which is greater than the total quantity of fluid flowing in the fluid connecting lines. An adequate supply of the bearing element with a fluid is therefore ensured continuously.

Furthermore, in a first embodiment, the bearing element can have a direction of action which is oriented counter to the radial direction of the element, the element being a rotating shaft, in particular a roll or a roll journal. In a second embodiment, it can have a direction of action which is oriented in the radial direction of the element, the element being a rotating hollow shaft, in particular a roll tube, and the bearing element being arranged in the interior of the hollow shell. Or else, in a third embodiment, it can have a direction of action which is oriented in the axial direction of the element, the element being a revolving element, in particular a disk or a ring. The bearing element is thus also distinguished by the fact that it can be used in all conceivable possible uses.

The object according to the invention is achieved in a hydrostatic bearing having at least one bearing element in that at least one hydrostatic lifting bearing is provided on the sliding surface of the element as a further supporting element for the purpose of producing restraining forces and has a sliding surface which is formed on a bearing body which is mounted on a guide element arranged in the bearing such that it can be displaced and tilted with respect to the bearing element.

This produces the advantage that a rotational movement, an axial movement and/or a small tilting movement of the element can be combined with one another as desired. In this case, however, the hydraulic restraining forces are clearly defined at all times.

Likewise, once again a fluid chamber can advantageously be formed between the guide element and the bearing body and can have a fluid under pressure applied to it through a hole in the guide element, so that the sliding surface of the supporting element is pressed against the bearing surface of the bearing.

Furthermore, a plurality of bearing elements and a plurality of lifting bearings will preferably be provided, the resultant directions of action of the bearing elements and of the lifting bearings being oriented vectorially toward one another. Therefore, no resultant force arises with all its disadvantages with regard to design of the mounting, dimensioning of the mounting and the like.

In a first configuration, the elements can be a rotating shaft, in particular a roll or roll journal, for the radial mounting of which two bearing elements and one lifting bearing are arranged on the circumference at a circumferential angle of in each case 120°±20° in the bearing. In a second embodiment, the element can be a rotating hollow shaft, in particular a roll tube, for the radial mounting of which two bearing elements and one lifting bearing are arranged on the inner circumference at a circumferential angle of in each case 120°±20°. Or, in a third embodiment, the element can be a revolving element, in particular a disk or a ring, for the axial mounting of which a plurality of axially aligned bearing elements are arranged on the secondary sliding surface and a plurality of axially aligned lifting bearings are arranged on the opposite tertiary sliding surface. The hydrostatic bearing is therefore distinguished by the fact that it can be used in all conceivable possible uses.

Further advantages, special features and expedient developments of the invention emerge from the following description of preferred exemplary embodiments with reference to the drawing, in which:

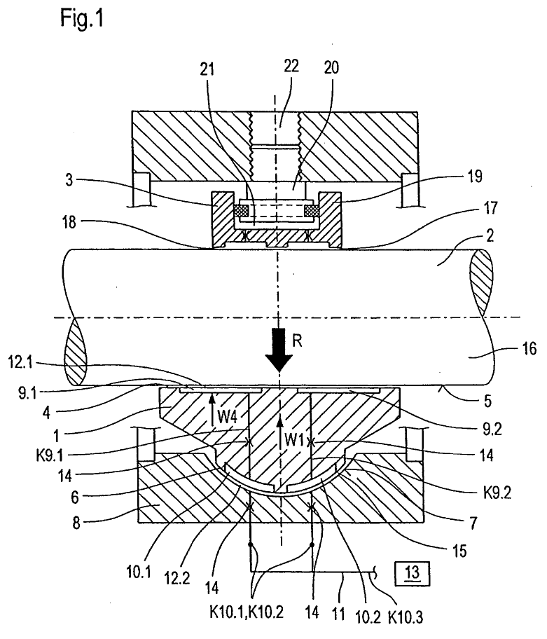

FIG. 1 shows a schematic cross-sectional illustration through an embodiment of a bearing element according to the invention having a lifting bearing arranged opposite the supported element;

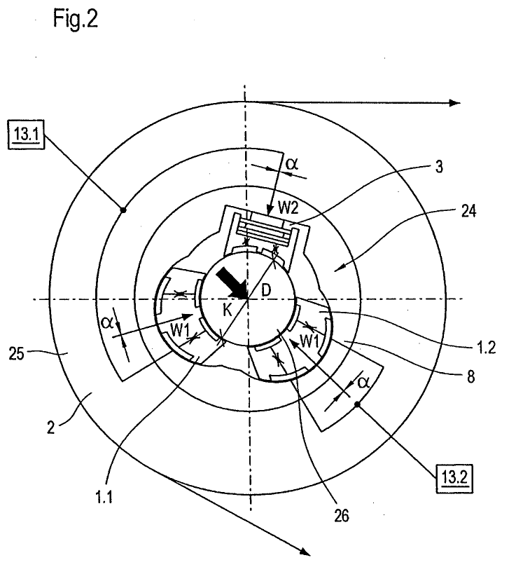

FIG. 2 shows a schematic side illustration of an embodiment of the hydrostatic bearing according to the invention having two bearing elements and one lifting bearing;

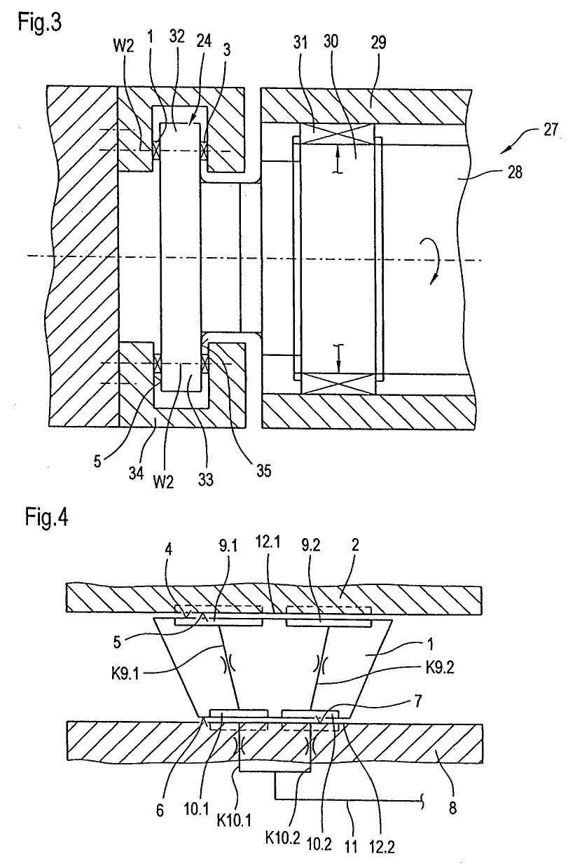

FIG. 3 shows a schematic longitudinal sectional illustration of a further embodiment of a hydrostatic bearing according to the invention; and

FIG. 4 shows a schematic and basic cross-sectional illustration of another embodiment of the bearing element according to the invention.

FIG. 1 shows a schematic cross-sectional illustration through an embodiment of the bearing element 1 according to the invention having a lifting bearing 3 arranged opposite the supported element 2.

The bearing element 1 has a primary sliding surface 4 for supporting a secondary sliding surface 5 of the element 2, and a primary bearing surface 6 for its own mounting on a secondary bearing surface 7 of a bearing 8. In this case, at least two lubrication pockets 9.1, 9.2 are arranged in the region of the primary sliding surface 4, and at least two bearing pockets 10.1, 10.2 are arranged in the region of the primary bearing surface 6, to which in each case at least one fluid 11 can be applied via channels K9.1, K9.2, K10.1, K10.2 during operation, in such a way that in each case a hydrostatic gap 12.1, 12.2 can be formed between the sliding surfaces 4, 5 (sliding gap 12.1) and the bearing surfaces 6, 7 (bearing gap 12.2).

The respective lubrication pocket 9.1, 9.2 of the primary sliding surface 4 is connected by means of a respective fluid connecting line (channel) K9.1, K9.2 to the respective corresponding bearing pocket 10.1, 10.2 of the primary bearing surface 6, arranged counter to the direction of action W4 (arrow), and the bearing pockets 10.1, 10.2 of the primary bearing surface 6 are in each case connected via the secondary bearing surface 7 by means of at least one fluid feed line (channel) K10.1, K10.2, which open in a conventional way into a main fluid feed line K10.3, to a fluid pressure source 13 which can preferably be regulated/controlled and which is already known from the prior art. Both each fluid connecting line K9.1, K9.2 and each fluid feed line K10.1, K10.2 to each bearing pocket 10.1, 10.2 has an element 14, in particular a restrictor, which produces a pressure drop in the event of through flow. The volume flow in each case resulting from the pressure drop determines the height of the respective gap 12.1, 12.2. The fluid feed lines K10.1, K10.2 (K10.3) also have a total amount of fluid flowing which is greater than the total amount of fluid flowing in the fluid connecting lines K9.1, K9.2.

The two bearing surfaces 6, 7 according to the embodiment of FIG. 1 have concave surface shapes, the two surfaces being parallel or approximately parallel to each other. In a further refinement, however, they can also have flat, convex or any desired surface shapes.

Furthermore, the number of lubrication pockets 9.1, 9.2 in the region of the primary sliding surfaces 4 is equal to the number of bearing pockets 10.1, 10.2 in the region of the primary bearing surface 6. The pockets 9.1, 9.2, 10.1, 10.2 can in this case have any desired external contour, for example in the form of a circle, a triangle, a square, a rectangle or a further polygon. It is merely important here that the respectively interconnected pockets 9.1, 10.1; 9.2, 10.2 of the primary surfaces 4, 6 have an equal or approximately equal area ratio and that the hydrostatically active total area at the gap 12.2 is smaller than the hydrostatically active total area at the gap 12.1. The pockets 9.1, 9.2, 10.1, 10.2 of the primary surfaces 4, 6 have a total area which lies in the range from 10 to 95% of the total active area of the pockets 9.1, 9.2, 10.1, 10.2 of the primary surfaces 4, 6. The term “total active area” is in this case best known to those skilled in the art.

In the region of the primary bearing surface 4, the bearing element 1 is spherical for the purpose of free angular setting and is mounted in a correspondingly oppositely formed sphere 15 of the bearing 8 in the secondary bearing surface 7. Moreover, the primary sliding surface 4 is shaped concavely and it embraces at most a circumferential angle of 180° of the preferably rotating element 2 (“half-round bearing shell”).

Furthermore, the bearing element 1 has a direction of action W1 (arrow) which is orientated counter to the radial direction R of the element 2. The element 2 is in this case a shaft 16, in particular a shaft journal. However, it can also be an externally supported and rotating hollow shaft.

Provided on the sliding surface 5 of the element 2 is a hydrostatic lifting bearing 3 as a further supporting element 17 for the purpose of producing restraining forces, which has a sliding surface 18 which is formed on a bearing element 19 mounted such that it can be displaced and tilted with respect to the bearing element 1 on a guide element 20 arranged in the bearing 8. Between the guide element 20 and the bearing element 19, a fluid chamber 21 is formed, to which a fluid 23 under pressure can be applied through a hole 22 in the guide element 20, so that the sliding surface 5 of the supporting element 17 is pressed against the bearing surface 7 of the bearing 8. According to the embodiment of FIG. 1, the lifting bearing 3 is arranged diametrically opposite the bearing element 1. In an altered constructional embodiment with reverse kinematics, the bearing element arranged in the interior of the element can have a direction of action which is oriented in the radial direction of the element. In this case, the element can be a rotating hollow shaft, in particular a roll tube.

FIG. 2 shows a schematic side illustration of an embodiment of the hydrostatic bearing 24 according to the invention having two bearing elements 1.1, 1.2 and a lifting bearing 3, which support a rotating element 2 in the configuration of a roll journal 26 of a roll 25, in particular a breast roll of a paper or board machine. This embodiment permits the roll journal to be moved axially; in particular periodic reciprocating movements are possible. The embodiments of the bearing elements 1.1, 1.2 and of the lifting bearing 3 correspond in principle to those of FIG. 1.

The two bearing elements 1.1, 1.2 and the lifting bearing 3 are mounted in a bearing 8 and they are arranged in the latter in a circumferential angle α of respectively 120°±20° in the bearing 24. In this case, the resultant directions of action of the bearing elements 1.1, 1.2 (directions of action W1 (arrow)) and of the lifting bearing 3 (direction of action W2 (arrow)) are oriented vectorially toward each other, so that the resultant bearing force K (arrow), composed of the fabric tensions and the roll weight, can be absorbed.

The bearing element 1.1 and the lifting bearing 3 are connected to a common first fluid pressure source 13.1 which can preferably be regulated/controlled, whereas the bearing element 1.2 is connected to a second fluid pressure source 13.2 which can preferably be regulated/controlled. In the case of an exemplary roll journal diameter D of 100 mm, the first fluid pressure source 13.1 produces a fluid pressure of 60 bar and a volume flow of 1 l/min for the bearing element 1.1 and of 0.4 l/min for the lifting bearing 3. By contrast, the second fluid pressure source 13.2 produces a fluid pressure of 160 bar and a volume flow of 2 l/min for the bearing element 1.2.

FIG. 3 shows a schematic longitudinal sectional illustration of a further embodiment of the hydrostatic bearing 24 according to the invention.

The schematically illustrated roll 27 comprises a support 28 and a roll tube 29 which can rotate with respect to the latter, the support 28 having at each end of the roll tube 29 a bearing ring 30 for a symbolically illustrated bearing 31 in order to support the roll tube 29. For the axial fixing of the support 28, the latter has, at least at one end, end side walls 32 in the form of a ring 33, which is supported with respect to a fixed bearing 34 by means of a plurality of hydrostatic and symbolically illustrated bearings 24. The hydrostatic bearings 24 therefore have a respective direction of action W2 which is oriented in the axial direction of the ring 33. For the purpose of axial mounting of the ring 33, a plurality of axially oriented and symbolically illustrated bearing elements 1 are provided on its secondary sliding surface 5, and a plurality of axially oriented and symbolically illustrated lifting bearings 3 are provided on the opposite tertiary sliding surface 35, all of which have the above-described features. Of course, the bearing 31 can also be constructed as a hydrostatic bearing element. With regard to the further possible design construction of the roll 27, reference is made to the German laid-open specification DE 100 20 834 A1.

FIG. 4 shows a schematic and basic cross-sectional illustration of a further embodiment of the bearing element 1 according to the invention, which in principle has the structure and the function of the bearing element 1 of FIG. 1. In this regard, reference is therefore made to the description of the bearing element 1 in FIG. 1.

However, the bearing element 1 has both a flat primary sliding surface 4 and a flat primary bearing surface 6. It is thus suitable in particular for supporting an element 2 which is mounted statically, that is to say in a fixed location, or rotationally. The element 2 can be, for example, a rotatable clamping plate, as disclosed in German patent specification DE 26 21 890 C2. The bearing 8 of the bearing element 1 is itself in turn preferably mounted in a fixed position.

In the region of the primary sliding surface 4 there are arranged at least two lubrication pockets 9.1, 9.2 and, in the region of the primary bearing surface 6, there are arranged at least two bearing pockets 10.1, 10.2, to which at least one fluid 11 can be applied via channels K9.1, K9.2, K10.1, K10.2 during operation, in such a way that in each case a hydrostatic gap 12.1, 12.2 can be formed between the sliding surfaces 4, 5 (sliding gap 12.1) and the bearing surfaces 6, 7 (bearing gap 12.2).

Of course, as also in the other exemplary embodiments, the two lubrication pockets 9.1, 9.2 can also be arranged in the region of the secondary sliding surface 5 (dashed illustration) and the two bearing pockets 10.1, 10.2, in the region of the secondary bearing surface 7 (dashed illustration), with the aforementioned function in each case.

In the sense of the invention, an above-described bearing element can be used at all points in a paper or board machine at which elements are mounted.

In summary, it is to be recorded that, by means of the invention, both a bearing element improved as compared with the prior art and a hydrostatic bearing having at least one bearing element is provided, which supports an element in a supportive manner on a sliding surface, the known disadvantages of the prior art not occurring and, in particular, the service life being increased as compared with the known bearings.

### LIST OF DESIGNATIONS

1, 1.1, 1.2 Bearing element
2 Element
3 Lifting bearing
4 Primary sliding surface (bearing element)
5 Secondary sliding surface (element)
6 Primary bearing surface (bearing element)
7 Secondary bearing surface (bearing)
8 Bearing
9.1, 9.2 Lubrication pocket
10.1, 10.2 Bearing pocket
11 Fluid
12.1 Hydrostatic gap (sliding gap)
12.2 Hydrostatic gap (bearing gap)
13 Fluid pressure source
13.1 First fluid pressure source
13.2 Second fluid pressure source
14 Element, in particular restrictor
15 Sphere
16 Shaft, in particular roll or roll journal
17 Supporting element
18 Sliding surface
19 Bearing body
20 Guide element
21 Fluid chamber
22 Hole
23 Fluid
24 Hydrostatic bearing
25 Roll
26 Roll journal
27 Roll
28 Support
29 Roll tube
30 Bearing ring
31 Bearing
32 Side wall
33 Ring
34 Fixed bearing
35 Tertiary sliding surface (element)
D Roll journal diameter
K Resultant bearing force (arrow)
K9.1, K9.2 Fluid connecting line (channel)
K10.1, K10.2 Fluid feed line (channel)
K10.3 Main fluid feed line
R Radial direction (arrow) (element)
W1 Direction of action (arrow) (bearing element)
W2 Direction of action (arrow) (hydrostatic bearing)
W4 Direction of action (arrow) (lubrication pocket)
α Circumferential angle

1. A bearing element comprising:
at least one first primary sliding surface that supports at least one secondary sliding surface of an element and having at least one second primary bearing surface for mounting on a second secondary bearing surface of a bearing, at least two lubrication pockets arranged in the region of the first primary and the secondary sliding surfaces and at least two bearing pockets being arranged in the region of the second primary bearing surface and the second secondary bearing surface, to which at least one fluid can be applied via channels during operation, in such a way that in each case a hydrostatic gap is formed between the first primary sliding surface and the secondary sliding surface and between the second primary bearing surface and the second secondary primary bearing surface;
wherein the respective lubrication pocket of the first primary sliding surface is connected by at least one respective fluid connecting line to the bearing pocket arranged in or counter to the direction of action, of the second primary bearing surface; and
wherein the bearing pockets of the second primary bearing surface are connected via the second secondary bearing surface, in each case by connecting at least one fluid feed line to a fluid pressure source which is regulated or controlled.

2. The bearing element of claim 1, wherein the respective second bearing surface and the second secondary bearing surface have at least one of flat, convex, concave and any desired surface shapes.

3. The bearing element of claim 1, wherein the number of lubrication pockets in the region of the first primary sliding surface his equal to the number of bearing pockets in the region of the second primary bearing surface.

4. The bearing element of claim 1, wherein the respectively interconnected pockets of the preferably first and second primary surfaces have an equal or approximately equal area ratio.

5. The bearing element of claim 1, wherein the hydrostatically active total area at a first gap is less than the hydrostatically active total area at a second gap.

6. The bearing element of claim 5, wherein the pockets of the first and second primary surfaces have a total area which lies in the range from 10 to 95% of the total active area of the pockets of the first and second primary surfaces.

7. The bearing element of claim 1, wherein the fluid connecting line has a restrictor, which produces a pressure drop in the event of through flow.

8. The bearing element of claim 1, wherein the fluid feed line to each bearing pocket has a restrictor, which produces a pressure drop in the event of a through flow.

9. The bearing element of claim 1, wherein the bearing element is spherical in the region of the second primary bearing surface for the purpose of free angular adjustment, and wherein the bearing element is mounted over an area in the second secondary bearing surface in a correspondingly oppositely formed sphere of the bearing, and wherein the second primary bearing and the second secondary bearing surface are parallel or approximately parallel to each other.

10. The bearing element of claim 1, wherein the first primary sliding surface is concave and embraces at most a circumferential angle of 180° of the elements.

11. The bearing element of claim 1, wherein the fluid feed line has a total amount of fluid flowing which is greater than the total amount of fluid flowing in the fluid connecting lines.

12. The bearing element of claim 1, wherein the bearing element has a direction of action which is oriented counter to the radial direction of the element, and wherein the element is a rotating shaft.

13. The bearing element of claim 1, wherein the bearing element has a direction of action which is oriented in the radial direction of the element, and wherein the element is a rotating hollow shaft, and wherein the bearing element is arranged in the interior of the hollow shaft.

14. The bearing element of claim 1, wherein the bearing element has a direction of action which is oriented in the axial direction of the element, and wherein the element is a revolving element, and wherein the revolving element is at least one of a disk and a ring

15. A hydrostatic bearing having at least one bearing element of claim 1, wherein at least one hydrostatic lifting bearing is provided on the secondary sliding surface of the element as a further supporting element that produces restraining forces and has a sliding surface on a bearing body which is mounted on a guide element arranged in the bearing such that it can be displaced and tilted with respect to the bearing element.

16. The hydrostatic bearing of claim 15, further comprising a fluid chamber between the guide element and the bearing body having a fluid under pressure applied to it through a hole in the guide element, so that the sliding surface of the supporting element is pressed against the second secondary bearing surface of the bearing.

17. The hydrostatic bearing of claim 15, further comprising a plurality of bearing elements and a plurality of lifting bearings, the resultant directions of action of the bearing elements and of the lifting bearings being oriented vectorially toward one another.

18. The hydrostatic bearing of claim 15, wherein the element is a rotating shaft, and wherein, for its radial mounting, two bearing elements and one lifting bearing are arranged on the circumference at a circumferential angle (α) of in each case 120°±20° in the bearing.

19. The hydrostatic bearing of claim 15, wherein the element is a rotating hollow shaft, and wherein, for its radial mounting, two bearing elements and one lifting bearing are arranged on the inner circumference at a circumferential angle (α) of in each case 120°±20°.

20. The hydrostatic bearing of claim 15, wherein the element is a revolving element, and wherein the revolving element is at least one of a disk and a ring, and wherein, for its axial mounting, a plurality of axially aligned bearing elements are arranged on the secondary sliding surface and a plurality of axially aligned lifting bearings are arranged on the opposite tertiary sliding surface.

21. The bearing element of claim 12, wherein the rotating shaft is at least one of a roll and a roll journal.
